(19) United States
(12) Patent Application Publication
(10) Pub. No.: US 2014/0023248 A1
(43) Pub. Date: Jan. 23, 2014

(54) APPARATUS AND METHOD FOR PROTECTING PRIVACY INFORMATION BASED ON FACE RECOGNITION

(71) Applicant: Electronics and Telecommunications Research Institute, Dejeon (KR)

(72) Inventors: Jang-Hee Yoo, Dejeon (KR); So Hee Park, Dejeon (KR); Yongjin Lee, Dejeon (KR); Jin-Woo Choi, Dejeon (KR)

(73) Assignee: Electronics and Telecommunications Research Institute, Daejeon (KR)

(21) Appl. No.: 13/947,055

(22) Filed: Jul. 20, 2013

(30) Foreign Application Priority Data
Jul. 20, 2012 (KR) 10-2012-0079444

(51) Int. Cl. G06K 9/00

(52) U.S. Cl. CPC G06K 9/00288
USPC 382/118

(57) ABSTRACT

An apparatus and method protects leakage of privacy information by detecting a specific person using a face recognition technology from a video image stored in a video surveillance system and performing privacy masking or mosaic processing on a face of the specific person or faces of other people.

### RELATED APPLICATIONS(S)

This application claims the benefit of Korean Patent Application No. 10-2012-0079444, filed on Jul. 20, 2012, which is hereby incorporated by references as if fully set forth herein.

### FIELD OF THE INVENTION

The present invention relates to a technology of protecting privacy information based on face recognition in video images stored in a video surveillance system, and more particularly, to an apparatus and method for protecting privacy information based on face recognition, which is capable of preventing privacy information from being leaked by detecting a specific person and selectively performing privacy masking or mosaic processing on a face of the specific person or faces of others except the specific person, wherein the specific person is a search target and detected from video image information, which is written/stored in a video surveillance system such as CCTV/DVR (closed-circuit television/digital video recorder), using a face recognition technology.

### BACKGROUND OF THE INVENTION

Recently, video surveillance systems such as CCTV/DVR are being distributed and installed in a rapid speed for the purpose of security and safety. These systems may collect a variety of image information even in a long distance using high-definition and high-magnification technologies, and an amount of collected information is increasing steeply so that it is difficult to control the increasing information.

However, in case an affair occurs, a case of searching for necessary information, e.g., a specific person, from a large amount of image information happens frequently, but this kind of searching work is difficult and consumptive.

Meanwhile, as described above, as the CCTV/DVR based video surveillance systems are rapidly distributed, problems relating to the protection of privacy are becoming importance issues.

As a method of protecting privacy, according to Act on the Protection of Privacy Information, it is enforced to perform mosaic processing on other people's images in case of providing image information of CCTV/DVR. However, since satisfactorily automated methods for that purpose have not been developed yet, it has to rely on manual labor to perform the mosaic processing.

In addition, various methods for protecting privacy information such as a face, a number plate, and the like from image information obtained from CCTV/DVR are being developed, but a method of masking all of object regions detected using an existing object detecting method in a real-time CCTV monitoring environment or a method of scrambling or encrypting the object regions using encryption keys, i.e., a method of modifying images and then recovering the images when required, is mainly being used.

These methods are mostly used in a process of monitoring or storing CCTV images. Therefore, they are slightly different from a method used to analyze stored images.

Accordingly, there is a need to develop a new technology for the automation of a privacy information protection method for video image information such as a mosaic processing method mostly relying on manual labor, thereby prohibiting unauthorized exposure or publication of the video image information.

### SUMMARY OF THE INVENTION

Embodiments of the present invention are directed to an apparatus and method for protecting privacy information based on face recognition, which is capable of preventing privacy information from being leaked by detecting a specific person and selectively performing privacy masking or mosaic processing on a face of the specific person or faces of others except the specific person, wherein the specific person is a search target and detected from video image information, which is written/stored in a video surveillance system such as CCTV/DVR, using a face recognition technology.

In accordance with an aspect of the present invention, there is provided an apparatus for protecting privacy information, the apparatus including: an image frame division unit configured to divide a search target video sequence into a plurality of image frames; a face detection unit configured to detect a face region from each of the image frames; a face recognition unit configured to perform face recognition by comparing face information of a face extracted from the face region with face information of a search target face and determining whether the extracted face is substantially the same as the search target face; and a privacy processing unit configured to distinguish between a first face determined to be substantially the same as the search target face and a second face determined not to be substantially the same as the search target face, and perform image processing to selectively mask a face region of the first face or that of the second face, wherein the second face is one of two or more faces except for the first face.

The privacy processing unit may distinguish between the first face and the second face and selectively perform privacy masking or mosaic processing on the first or second face, or a person region of the first or second face.

The privacy processing unit may perform privacy masking or mosaic processing on the second face or a person region of the second face.

The apparatus may further include a person detection unit configured to detect a person region from each of the image frames.

The face detection unit may detect the face region from the person region.

The apparatus may further include a privacy level selection unit configured to determine an image processing region for privacy masking or mosaic processing, which is to be performed in the privacy processing unit, according to a predetermined condition.

The image frame division unit may decode the search target video sequence and divide a video sequence into the image frames.

The face detection unit may detect the face region using one or more of a knowledge-based scheme, a feature invariant scheme, a template matching scheme, and an appearance-based scheme.

The face recognition unit may perform the face recognition on the face region using one or more of a Gabor filter, a principal component analysis (PCA), a Fisher discriminate analysis (FDA), an independent component analysis (ICA), local binary feature (LBP), and a support vector machine (SVM).

In accordance with another aspect of the present invention, there is provided a method of protecting privacy information, the method including: dividing a search target video sequence into a plurality of image frames; detecting a face region from each of the image frames; comparing face information of a face extracted from the face region with face information of a search target face and determining whether the extracted face is substantially the same as the search target face; and distinguishing between a first face determined to be substantially the same as the search target face and a second face determined not to be substantially the same as the search target face, and performing image processing to selectively mask a face region of the first face or that of the second face, wherein the second face is one of two or more faces except for the first face.

Detecting the face region may include detecting a person region from each of the image frames, and detecting the face region from the person region.

Performing the image processing may include selectively performing privacy masking or mosaic processing on the first or second face, or a person region of the first or second face.

Performing the image processing may include performing privacy masking or mosaic processing on the second face or a person region of the second face.

The image processing may be performed to process an image processing region for privacy masking or mosaic processing, which is determined according to a predetermined condition.

Dividing the search target video sequence may include decoding the search target video, and dividing a video sequence of the decoded video into the image frames.

The embodiments of the present invention have an advantage of preventing privacy information from being leaked by detecting a specific person and selectively performing privacy masking or mosaic processing on a face of the specific person or faces of other people except the specific person, wherein the specific person is a search target and detected from video image information, which is written/stored in a video surveillance system such as CCTV/DVR, using a face recognition technology.

In addition, by applying the face recognition technology to high-capacity video image information stored in a DVR/image storage device to detect the specific person and then selectively performing the privacy masking or mosaic processing on the specific person or other people than the specific person, it is possible to automatically implement the privacy information protection for the video image information. That is, in case of providing privacy image information according to Act on the Protection of Privacy Information, it is possible to more easily and effectively perform existing very difficult and consumptive works necessary to perform the mosaic processing on images of other people through the automation of the privacy information protection.

Moreover, it is possible to implement the automation of privacy information protection for a plate number by applying the same method as for the face, so that it has an advantage of effectively coping with high-speech searching of the specific person. Therefore, it is possible to more effectively obey the Act on the Protection of Privacy Information and substantially contribute to the development of related technologies for supporting the privacy information protection.

### BRIEF DESCRIPTION OF THE DRAWINGS

The above and other objects and features of the present invention will become apparent from the following description of embodiments given in conjunction with the accompanying drawings, in which:

FIG. 1 illustrates a detailed block diagram of an apparatus for protecting privacy information based on face recognition in accordance with an embodiment of the present invention;

FIG. 2 illustrates screens showing face regions and person regions that are detected in an apparatus for protecting privacy information in accordance with an embodiment of the present invention;

FIG. 3 illustrates screens showing face regions that are detected in an apparatus for protecting privacy information in accordance with an embodiment of the present invention;

FIG. 4 illustrates screens showing the comparison between a search target face and detected face regions in accordance with an embodiment of the present invention;

FIG. 5 illustrates screens on which a masking process is performed to protect privacy information in accordance with an embodiment of the present invention; and

FIG. 6 is a flowchart showing operations performed in an apparatus for protecting privacy information in accordance with an embodiment of the present invention.

### DETAILED DESCRIPTION OF THE EMBODIMENTS

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

The combinations of each block of the accompanying block diagram and each step of the accompanying flowchart may be performed by computer program instructions. These computer program instructions may be loaded on a processor of a general-purpose computer, a special-purpose computer, or other programmable data processing equipments. Therefore, the instructions performed by the processor of the computers or other programmable data processing equipments generate units for performing functions explained in each step of the flowchart or each block of the block diagram. Since the computer program instructions can be stored in a computer usable memory or a computer readable memory to be employed in a computer or other programmable data processing equipments to implement functions of the instructions in a specific manner, the instructions stored in the computer usable memory or the computer readable memory can be manufactured as products employing an instruction unit for performing functions explained in each step of the flowchart or each block of the block diagram. Since the computer program instructions can be loaded on the computer or other programmable data processing equipments, a sequence of operating steps is performed on the computer or other programmable data processing equipments to generate a process performed by the computer. Therefore, the instructions processed by the computer or other programmable data processing equipments can provide steps of performing the functions explained in each step of the flowchart and each block of the block diagram.

In addition, each block or each step may represent a part of a module, a segment, or a code including at least one executable instruction for performing specific logical function(s). In accordance with other embodiments, it is noted that the functions mentions in the blocks or steps can be performed regardless of their order. For instance, two blocks or steps illustrated sequentially can be simultaneously performed or the blocks or steps can be performed in reverse order according to their functions.

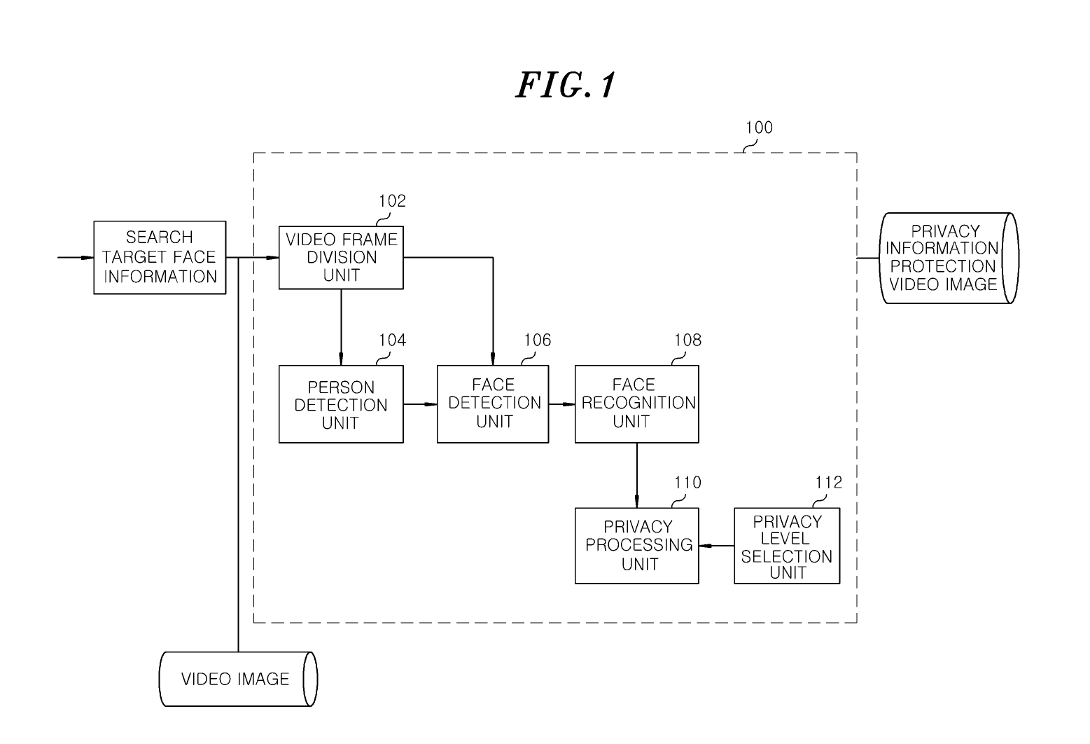

FIG. 1 illustrates a detailed block diagram of an apparatus for protecting privacy information based on face recognition in accordance with an embodiment of the present invention. Hereinafter, the apparatus will be referred to as a privacy information protection device.

The privacy information protection device 100 includes a video frame division unit 102, a person detection unit 104, a face detection unit 106, a face recognition unit 108, a privacy processing unit 110, and a privacy level selection unit 112.

First of all, the privacy information protection device 100 receives search target face information such as a picture image to select a target or a non-target of privacy masking or mosaic processing. At this time, the search target face information may include face information of at least one search target. In order to improve search performance by more effectively applying a face recognition technology, the search target face information may be modified or characteristic information of a face may be selected. As described above, after receiving the search target face information, the privacy information protection device 100 receives a search target video sequence, determines a first face region that corresponds to the search target face information or a second face region that does not correspond to the search target face information from the search target video sequence through the face recognition, selectively performs the privacy masking or mosaic processing on the first face region or the second face region according to conditions designated by a user, and outputs a privacy information protected video image that is processed to protect privacy information. Here, the second face region may be one of two or more face regions except for the first face region

Hereinafter, operations of processing the search target face information and the search target video sequence, which are performed at components in the privacy information protection device 100, will be described in detail with reference to FIG. 1.

The video frame division unit 102 is provided with the search target video sequence, decodes the search target video to analyze it, and divides a video sequence of the decoded video into a plurality of image frames.

In order to recognize a face of a person from each of the divided image frames, it is required to detect a face region on which the face recognition is to be performed. At this time, for more effectively performing the face detection, a person region may be first detected, and then the face may be detected from the detected person region, according to the need.

That is, the person detection unit 104 detects a person region from each of the image frames obtained at the image frame division unit 102, and the face detection unit 106 detects a face from each of the image frames or the person region detected at the person detection unit 104.

A face detection method used at the face detection unit 106 may include any of a knowledge-based method, a feature invariant method, a template matching method, and an appearance-based method.

Information on the face detected by the face detection unit 106 is processed through feature extraction and classification, or recognition, and then determined whether or not it is identical to the search target face information at the face recognition unit 108. At this time, various feature extraction and recognition algorithms such as a Gabor filter, a principal component analysis (PCA), a Fisher discriminate analysis (FDA), an independent component analysis (ICA), local binary feature (LBP), and a support vector machine (SVM) may be used to perform the face recognition.

In general, if it is determined that faces in the detected face regions are not identical to the search target face, the faces in the detected face regions are defined as other people and thus processed by the privacy masking or mosaic processing. These methods are to hide face regions of the other people except the search target so that face information of the other people is not exposed.

The privacy processing unit 110 performs the privacy masking or mosaic processing to mask the whole faces of the other people, which are determined to be non-identical to the search target face as a result of the face recognition performed at the face recognition unit 108.

In accordance with another embodiment, a face, which is determined to be identical to the search target face, may be masked by the privacy masking or mosaic processing. In accordance with another embodiment, when employing the person detection unit 104, the privacy masking or mosaic processing may be performed on the whole person region in addition to a face. The privacy level selection unit 112 may be configured to determine a region and/or a target to be selectively masked by the privacy masking or mosaic processing according to a predetermined condition, thereby determining whether or not the above processes are performed.

That is, the privacy level selection unit 112 determines whether or not performing the privacy masking or mosaic processing on the whole person region as well as a face according to the predetermined condition, provides the determined result as a privacy level to the privacy processing unit 110. The privacy processing unit 110 performs the privacy masking or mosaic processing on the face or the whole person region according to the privacy level.

Through the above processes, the video image is converted into a privacy information protected video image on which the privacy information protection is performed.

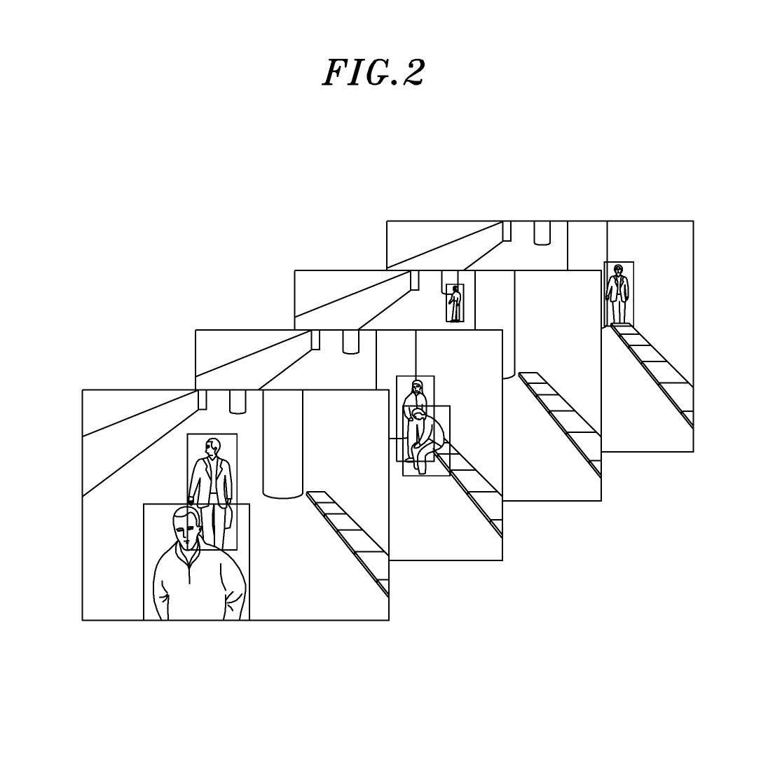

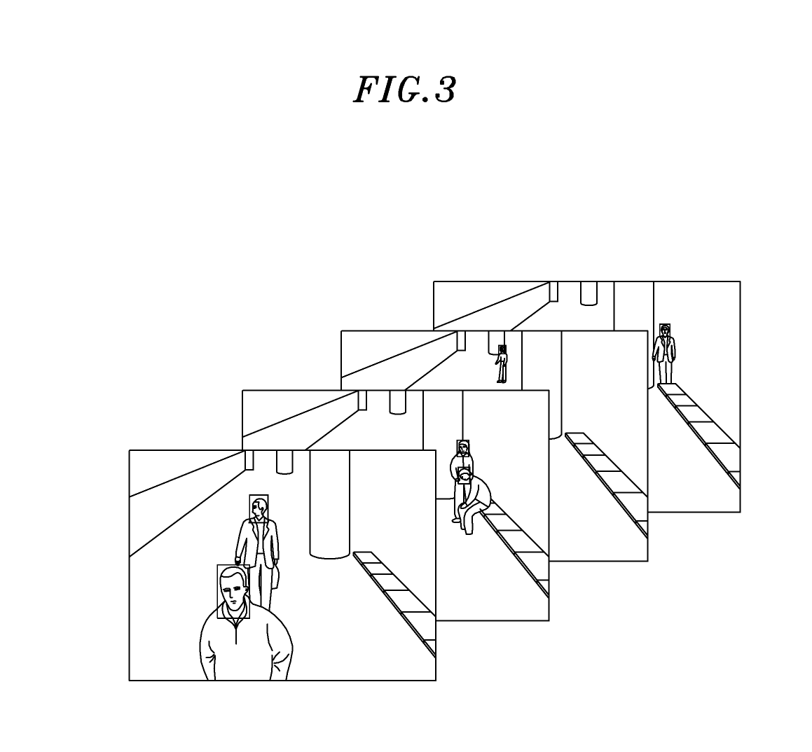

FIG. 2 illustrates screens showing face regions and person regions that are detected at the person detection unit 104 and the face detection unit 106, respectively, from each image frame of a video sequence in accordance with an embodiment of the present invention. FIG. 3 illustrates screens showing face regions that are detected by the face detection unit 106 in accordance with an embodiment of the present invention.

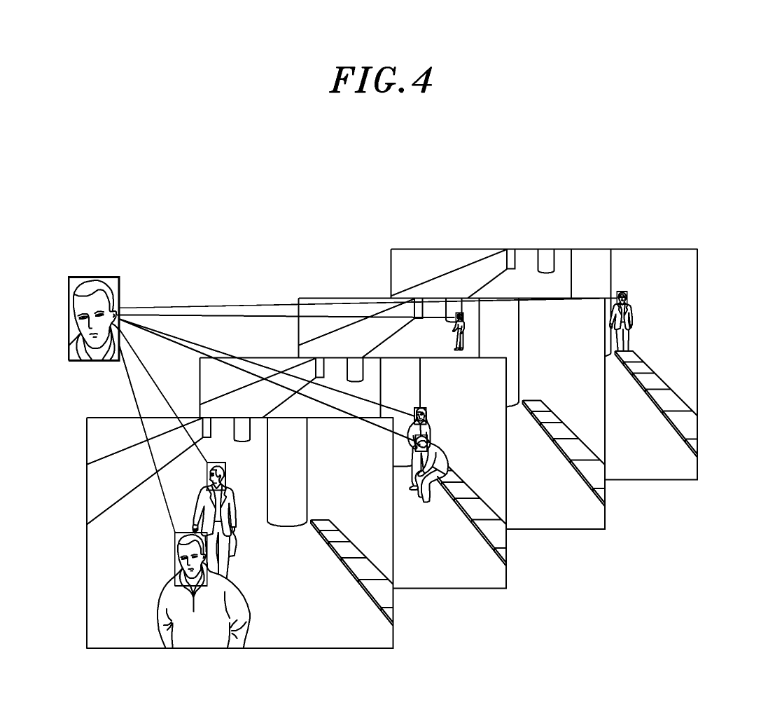

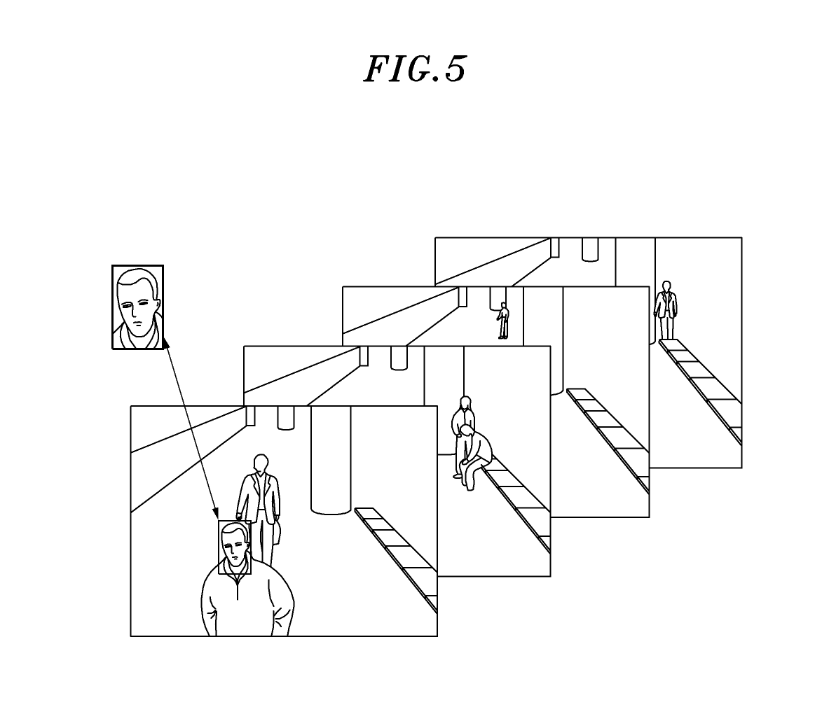

FIG. 4 illustrates screens showing a process of comparing a search target face and face regions detected from the video image by applying the face recognition technology, the comparison process being performed at the face recognition unit 108. FIG. 5 illustrates screens on which other face regions than face regions that are determined to be identical to the search target face are masked according to the comparison result.

As shown in FIG. 5, the face regions, which are determined to be non-identical to the search target face, are masked to protect privacy information, so that it is possible to secure the video image to which the person information protection is applied.

As described above, by sequentially and automatically performing the face detection, the face recognition, and the masking or mosaic processing on the video image for the privacy information protection, it is possible to more rapidly execute the mosaic processing of the video image compared to the conventional method of manually performing the mosaic processing.

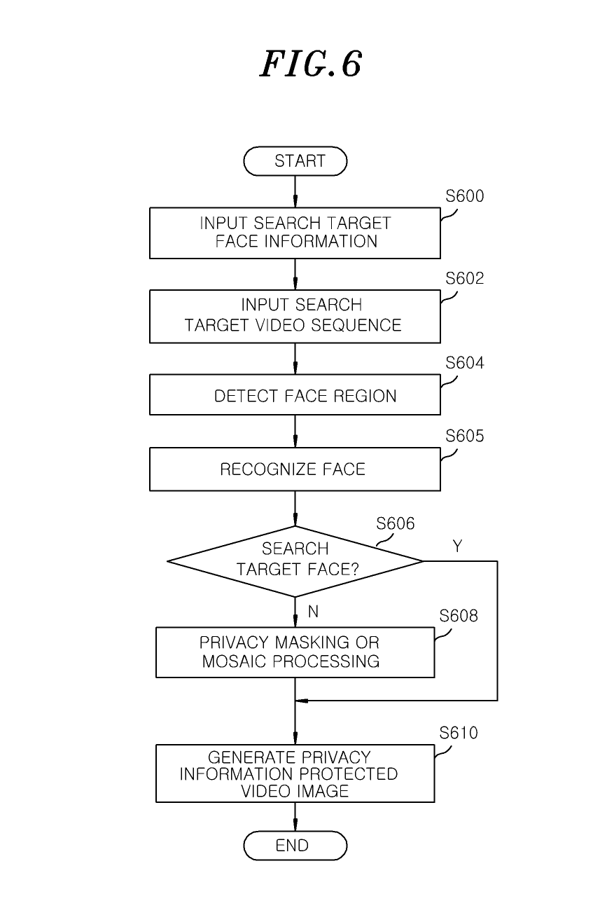

FIG. 6 is a flowchart of executing the mosaic processing to protect the privacy information, which is performed in the privacy information protection device 100 based on the face recognition in accordance with an embodiment of the present invention. Hereinafter, an embodiment of the present invention will be described in detail with reference to FIGS. 1 to 6.

First of all, in step S600, the privacy information protection device 100 receives search target face information such as a picture image to select a target or a non-target for the privacy masking or mosaic processing. The search target face information may include face information of at least one search target. To enhance search performance by more effectively applying a face recognition technology, the search target face information may be modified, or characteristic information of a face may be selected.

After receiving the search target face information, the privacy information protection device 100 receives a search target video sequence in step S600, detects a face that is identical to a search target face from the search target video sequence through the face recognition, performs the privacy masking or mosaic processing on the detected face, and outputs a privacy information protected video image that is modified to protect the privacy information. In the above processes, an order of the inputting of the search target face information (S600) and the inputting of the search target video sequence (S602) may be reversed.

When the search target video sequence is inputted, the privacy information protection device 100 decodes the video sequence to analyze the video image and divides a video sequence of the decoded video into a plurality of image frames.

After that, in step S604, the privacy information protection device 100 detects a face region on which the face recognition is to be performed from each of the divided image frames. At this time, to more effectively perform the face detection, a person region may be first detected, and then the face region is detected from the detected person region, according to the need.

That is, the privacy information protection device 100 detects the person region as shown in FIG. 2 from each of the divided image frames, and then detects the face region as shown in FIG. 3 from the detected person region.

At this time, the face detection method may include any of a knowledge-based method, a feature invariant method, a template matching method, and an appearance-based method.

Subsequently, the privacy information protection device 100 performs the face recognition on the face region detected from the search target video sequence in step S605, and then determines whether or not a recognized face is identical to the search target face in step S606.

Various feature extraction and recognition algorithms such as a Gabor filter, a principal component analysis (PCA), a Fisher discriminate analysis (FDA), an independent component analysis (ICA), local binary feature (LBP), or a support vector machine (SVM) may be applied for the face recognition.

As a result of the determination in step S606, if the recognized face is determined to be non-identical to the search target face, the privacy information protection device 100 defines the recognized face as a stranger, and performs the privacy masking or mosaic processing on the recognized face in step S608 as shown in FIG. 5.

In accordance with another embodiment, the privacy masking or mosaic processing may be performed on the recognized face that is determined to be identical to the search target face. Moreover, in case of applying a privacy information protection range to the person region, the privacy masking or mosaic processing may be performed on the whole person region as well as the face.

As a result, if faces detected from the search target video sequence are not the search target face, the privacy information protection device 100 sequentially performs the privacy masking or mosaic processing on the detected faces and generates a privacy information protected video image where the privacy information is protected in step S610.

As described above, in the privacy information protection method based on the face recognition, it is possible to prevent the leakage of privacy information by detecting a specific person, which is a search target, from video image information written/stored in a video surveillance system such as CCTV/DVR based on a face recognition technology, and then selectively performing the privacy masking or mosaic processing on the specific person or face images except the specific person.

By applying the face recognition technology to high-capacity video image information stored in a DVR/image storage device to detect the specific person and then selectively performing the privacy masking or mosaic processing on the specific person or other people than the specific person, it is possible to automatically implement the privacy information protection for the video image information. That is, in case of providing privacy image information according to Act on the Protection of Privacy Information, it is possible to more easily and effectively perform existing very difficult and consumptive works necessary to perform the mosaic processing on images of other people through the automation of the privacy information protection.

While the invention has been shown and described with respect to the preferred embodiments, the present invention is not limited thereto. It will be understood by those skilled in the art that various changes and modifications may be made without departing from the scope of the invention as defined in the following claims.

What is claimed is:

1. An apparatus for protecting privacy information, comprising:
an image frame division unit configured to divide a search target video sequence into a plurality of image frames;
a face detection unit configured to detect a face region from each of the image frames;
a face recognition unit configured to perform face recognition by comparing face information of a face extracted from the face region with face information of a search target face and determining whether the extracted face is substantially the same as the search target face; and
a privacy processing unit configured to distinguish between a first face determined to be substantially the same as the search target face and a second face determined not to be substantially the same as the search target face, and perform image processing to selectively mask a face region of the first face or that of the second face,
wherein the second face is one of two or more faces except for the first face.

2. The apparatus of claim 1, further comprising:
a person detection unit configured to detect a person region from each of the image frames.

3. The apparatus of claim 2, wherein the face detection unit is configured to detect the face region from the person region.

4. The apparatus of claim 1, wherein the privacy processing unit is configured to distinguish between the first face and the second face and selectively perform privacy masking or mosaic processing on the first or second face, or a person region of the first or second face.

5. The apparatus of claim 1, wherein the privacy processing unit is configured to perform privacy masking or mosaic processing on the second face or a person region of the second face.

6. The apparatus of claim 1, further comprising:
a privacy level selection unit configured to determine an image processing region for privacy masking or mosaic processing, which is to be performed in the privacy processing unit, according to a predetermined condition.

7. The apparatus of claim 1, wherein the image frame division unit is configured to decode the search target video sequence and divide a video sequence into the image frames.

8. The apparatus of claim 1, wherein the face detection unit is configured to detect the face region using one or more of a knowledge-based scheme, a feature invariant scheme, a template matching scheme, and an appearance-based scheme.

9. The apparatus of claim 1, wherein the face recognition unit is configured to perform the face recognition on the face region using one or more of a Gabor filter, a principal component analysis (PCA), a Fisher discriminate analysis (FDA), an independent component analysis (ICA), local binary feature (LBP), and a support vector machine (SVM).

10. A method of protecting privacy information, comprising:
dividing a search target video sequence into a plurality of image frames;
detecting a face region from each of the image frames;
comparing face information of a face extracted from the face region with face information of a search target face and determining whether the extracted face is substantially the same as the search target face; and
distinguishing between a first face determined to be substantially the same as the search target face and a second face determined not to be substantially the same as the search target face, and performing image processing to selectively mask a face region of the first face or that of the second face,
wherein the second face is one of two or more faces except for the first face.

11. The method of claim 10, wherein detecting the face region comprises:
detecting a person region from each of the image frames; and
detecting the face region from the person region.

12. The method of claim 10, wherein performing the image processing comprises:
selectively performing privacy masking or mosaic processing on the first or second face, or a person region of the first or second face.

13. The method of claim 10, wherein performing the image processing comprises:
performing privacy masking or mosaic processing on the second face or a person region of the second face.

14. The method of claim 10, wherein the image processing is performed to process an image processing region for privacy masking or mosaic processing, which is determined according to a predetermined condition.

15. The method of claim 10, wherein dividing the search target video sequence comprises:
decoding the search target video sequence; and
dividing a video sequence of the decoded video image into the image frames.
